(19) United States
(12) Patent Application Publication
(10) Pub. No.: US 2004/0035979 A1
(43) Pub. Date: Feb. 26, 2004

(54) Integrally stiffened axial load carrying skin panels for primary aircraft structure and closed loop manufacturing methods for making the same

(76) Inventors: William Robert McCoskey JR., Bothell, WA (US); Kenneth A. Hartsock, Marysville, WA (US); Theodore P. Nykreim, Gold Bar, WA (US)

Correspondence Address: HARNESS, DICKEY & PIERCE, P.L.C., P.O. BOX 828, BLOOMFIELD HILLS, MI, 48303, US

(21) Appl. No.: 10/226,922

(22) Filed: Aug. 23, 2002

(51) Int. Cl. B64C 1/00; B64D 1/00; B64C 30/00

(52) U.S. Cl. 244/117 R

(57) ABSTRACT

A skin panel is provided that includes an axial load carrying skin and at least one stiffener integrally engaged with the axial load carrying skin. The stiffener includes at least one of a stringer, a frame outer chord, and a flange disposed at about an edge of the skin panel. The skin and the at least one stiffener are integrally formed as a single component structure. Accordingly, the invention provides integrally stiffened axial load carrying skin panels suitable for use in any of a wide range of aircraft structures that employ axial load carrying skins, such as fuselages, wings, empennages, pressure bulkheads, wing carry through sections, escape hatches, passenger doors, cargo doors, and access hatches and panels, among others.

### FIELD OF THE INVENTION

The present invention relates generally to aircraft and more particularly to axial load carrying skin panels for primary aircraft structure and methods for making the same.

### BACKGROUND OF THE INVENTION

The current method of designing and constructing primary airliner structures (e.g., fuselages, wings, empennage, pressure bulkheads, wing carry through, escape hatches, passenger doors, cargo doors, etc.) is called semi-monocoque. The semi-monocoque structure contains thousands of detail parts riveted into substantially transverse stiffeners or ribs (also called frames) and into substantially longitudinal stiffeners or ribs (also called stringers), both of which are riveted to the skin. Although semi-monocoque structures have been successful for their intended purpose, it would be even more desirable to provide structures that are even less labor intensive, costly, and time-consuming to design, fabricate and assemble.

More specifically, the design phase for a traditional semi-monocoque jetliner requires designing thousands of details, splices, and assemblies and specifying a whole range of rivet types, their respective locations and spacing. Fabricating thousands of detail parts and maintaining configuration control while doing so can be extremely complicated. Accordingly, a great number of fabrication shops are typically employed to fabricate the various parts of a semi-monocoque design for a major airliner. Indeed, it is not uncommon for a commercial jetliner to contain about three million (3,000,000) holes drilled through parts with an equal number of fasteners installed, which is all done and orchestrated through and by over one thousand (1000) fabrication shops.

Assembling a conventional semi-monocoque aircraft involves riveting thousands of detail parts into the frames and stringers, which in turn are riveted into the axial load carrying skins. The complex assembly of thousands of such detail parts requires specifications, fabrication, and tracking of a whole range of rivet types and small parts, their locations, spacings, etc. for fastening the thousands of parts into the monocoque structure. Accordingly, a great number of assembly shops are typically needed to assemble a conventional semi-monocoque aircraft. Indeed, it is not uncommon for nearly one (hundred) assembly shops to be involved in the assembly of a commercial jetliner.

In view of the foregoing, it will be readily apparent that it would be highly beneficial to provide an aircraft structure that may be assembled with significantly less fastener holes, while those fastener holes which are still employed would facilitate a fully determinately assembled product requiring no or little drilling at the assembly operation.

Historical studies of aircraft indicate that fastener holes are the source or origination location for nearly all fuselage cracks, which tend to reduce the service life of the airframe. In addition, it is also known that fastener holes are the major culprit in the development of multi-site fatigue damage, fretting corrosion, and costly aircraft inspection, refurbishing and maintenance. With less fastener holes, less time would be needed for conducting routine inspections of and for repairing fastener holes to ensure the structural integrity of the airliner.

Providing an aircraft structure that is even less costly to design, fabricate, and assemble than the current semi-monocoque structures would be financially beneficial to both airframe manufacturers from the fabrication standpoint and to airline operators from the “Cost of Ownership” and maintenance standpoints. It is well known in the industry that “Cost of Ownership” has become the largest single fixed component of operating jetliner aircraft. The “Cost of Ownership” burden is shifting rapidly to the aircraft manufactures-with the increasing airline industry trend toward leasing rather than owning jetliners.

Although airline structure costs and the affordability thereof are dependent at least in part on the time and labor required for and complexities associated with the design, fabrication, and assembly of the aircraft structure, other factors also are important. Aircraft structure costs, affordability and to a degree weight are driven not only by large part counts, but also by failsafe considerations and by stringer splice repair procedures. On the one hand, there is the increased cost of designing, testing and life demonstration; and on the other hand, wherever service life may be limited or reduced, there is naturally the increased cost of inspections and stringer splice repairs associated with large numbers of fastener holes.

Furthermore, the number of aircraft manufacturers owning commercial aircraft has increased as a result of the increasing trend of airline operators to lease rather than own commercial aircraft. Accordingly, it would be beneficial to such aircraft manufacturers to increase the service life and economically viable life limit of operating their commercial jetliner inventory. Thus, it would be beneficial to provide structures that are even more durable and damage-tolerant and have increased fatigue capabilities.

### SUMMARY OF THE INVENTION

Generally, the present invention provides a skin panel that includes an axial load carrying skin and at least one stiffener integrally engaged with the axial load carrying skin. The stiffener includes at least one of a stringer, a frame outer chord, and a flange disposed at about an edge of the skin panel. The axial load carrying skin and the stiffener are integrally formed as a single component structure. Accordingly, the invention provides integrally stiffened axial load carrying skin panels suitable for use in any one of a wide range of aircraft structure that translate loads between axially load carrying skins and stiffening features (e.g., ribs, stiffeners, frame outer chords,, stringers, etc.) and/or flanges.

In one exemplary form, the present invention provides a fuselage skin panel that includes an axial load carrying skin, a plurality of stringers, and a plurality of frame outer chords. The fuselage skin panel may also include substantially longitudinal flanges and substantially transverse flanges, each of which is disposed at a respective edge of the fuselage skin panel. Additionally, the fuselage skin panel may also include one or more integrally reinforced window frames. Preferably, the axial load carrying skin, stringers, frame outer chords, flanges, and window frames are all integrally formed together as a single component structure.

In yet another form, the present invention provides a method for making a skin panel for use with any of a wide range of aircraft structures that employ an axial load carrying skin. Preferably, the method comprises the step of integrally forming an axial load carrying skin and at least one stiffener as a single component structure.

Further areas of applicability of the present invention will become apparent from the detailed description provided hereinafter. It should be understood that the detailed description and specific examples, while indicating at least one preferred embodiment of the invention, are intended for purposes of illustration only and are not intended to limit the scope of the invention.

### BRIEF DESCRIPTION OF THE DRAWINGS

The present invention will be more fully understood from the detailed description and the accompanying drawings, wherein:

FIG. 1 is an inward perspective view of an integrally stiffened axial load carrying fuselage skin panel according to one preferred embodiment of the present invention;

FIG. 2 is another inward perspective view of the fuselage skin panel shown in FIG. 1;

FIG. 3 is a outside perspective view of the fuselage skin panel shown in FIG. 1;

FIG. 4 is a perspective view of an exemplary aircraft and showing the fuselage skin panel of FIG. 1;

FIG. 5 is a detailed perspective view of a pocket of the fuselage skin panel shown in FIG. 1;

FIG. 6 is an inward view of a portion of the fuselage skin panel shown in FIG. 1 in which a crack has formed within a pocket thereof;

FIG. 7 is a cross-sectional view taken along the planes 7-7 shown in FIG. 6;

FIG. 8 is an upper view of an intersection between a stringer and a frame outer chord shown in FIG. 6;

FIG. 9 is a cross-sectional view taken along the plane 9-9 in FIG. 6;

FIG. 10 is a detailed perspective view of an intersection of a substantially transverse flange and a substantially longitudinal flange of the fuselage skin panel shown in FIG. 1;

FIG. 11 is a perspective view of an integrally reinforced window frame of the fuselage skin panel shown in FIG. 1;

FIG. 12 is a detailed perspective view of the integrally reinforced window frame shown in FIG. 11;

FIG. 13 is a detailed cross-sectional view of the window frame taken along the plane 13-13 in FIG. 11;

FIG. 14 is a perspective view of three separate fuselage skin panels shown engaged with secondary frame members in accordance with the principles of the present invention;

FIG. 15 is a detailed cross-sectional view taken along the plane 15-15 in FIG. 14;

FIG. 16 is an inward view of a pocket of a fuselage skin panel according to a second embodiment of the present invention;

FIG. 17 is a detailed cross-sectional view taken along the plane 17-17 in FIG. 16;

FIG. 18 is an inward view of a fuselage skin panel according to a third embodiment of the present invention;

FIG. 19 is a plan view of the substantially curved flange of the fuselage skin panel shown in FIG. 18;

FIG. 20 is an inward view of a fuselage skin panel according to a fourth embodiment of the present invention;

FIG. 21 is a cross-sectional view of a stringer taken along the plane 21-21 in FIG. 20; and

FIG. 22 is a cross-sectional view of a substantially longitudinal flange taken along the plane 22-22 in FIG. 20.

### DETAILED DESCRIPTION OF THE PREFERRED EMBODIMENTS

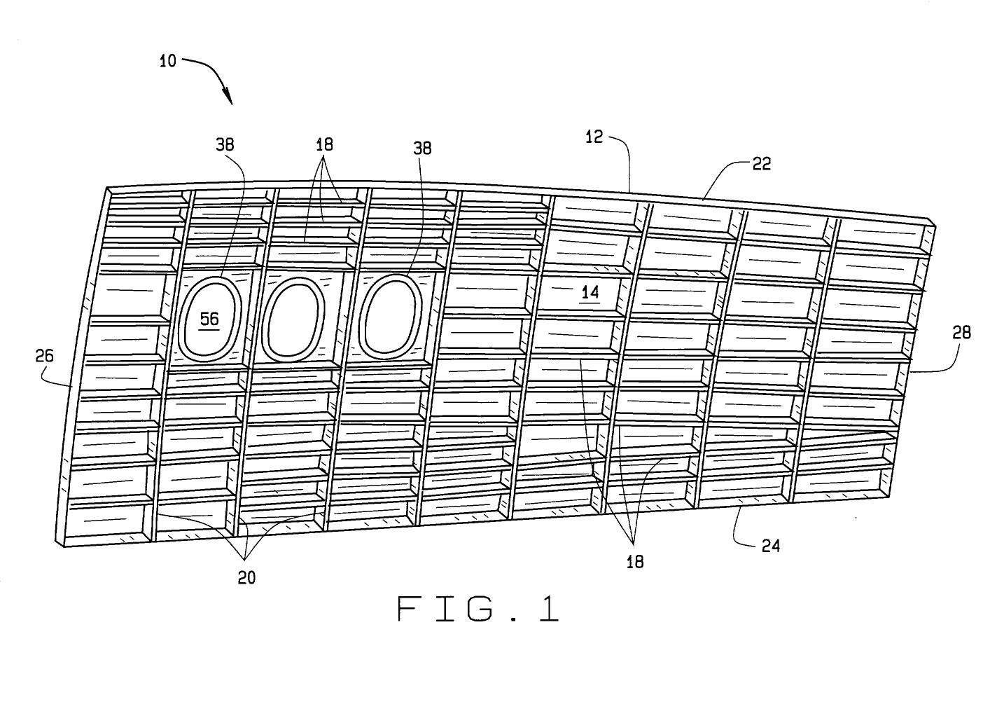

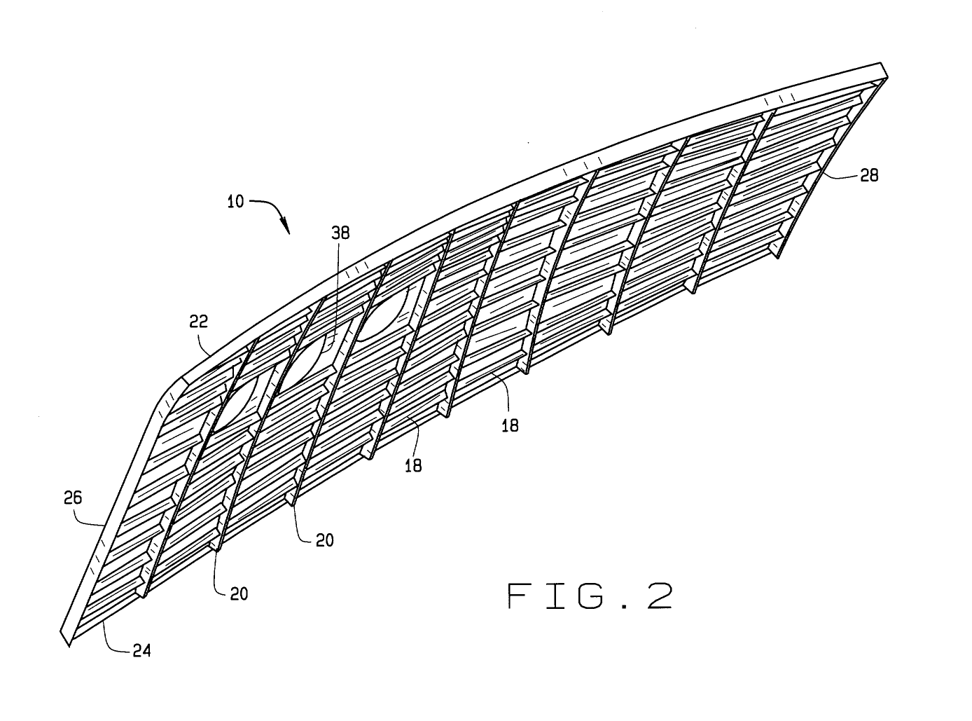

FIGS. 1 and 2 are inward perspective views of an exemplary integrally stiffened axial load carrying fuselage skin panel, generally indicated by reference number 10, according to one preferred embodiment of the present invention. FIG. 3 is also a perspective view of the fuselage skin panel 10 but showing the exterior thereof. Generally, the fuselage skin panel 10 includes an axial load carrying skin 12 having an inner surface 14 (FIG. 1) and an outer surface 16 (FIG. 3) and at least one stiffener integrally engaged with the axial load carrying skin 12. In the exemplary embodiment shown and described herein, the skin panel 10 is configured for use with a fuselage structure. The skin panel 10 includes a plurality of stringers 18 and frame outer chords 20. Each stringer 18 and frame outer chord 20 is integrally engaged or formed with the inner skin surface 14 and thus allow the stringers 18 and frame outer chords 20 to translate loads from and into the skin 12 in a manner such that stresses are not focuses into high concentrations.

To allow the skin panel 10 to be engaged with additional skin panels, the skin panel 10 preferably includes substantially longitudinal flanges 22 and 24 and substantially transverse flanges 26 and 28, each of which is integrally engaged at about a respective edge of the skin panel 10. The skin panel 10 may further include one or more integrally reinforced window frames 38. Accordingly, the present invention provides monolithic or unitary skin panels wherein the various components comprising the skin panel are integrally formed as a single component structure.

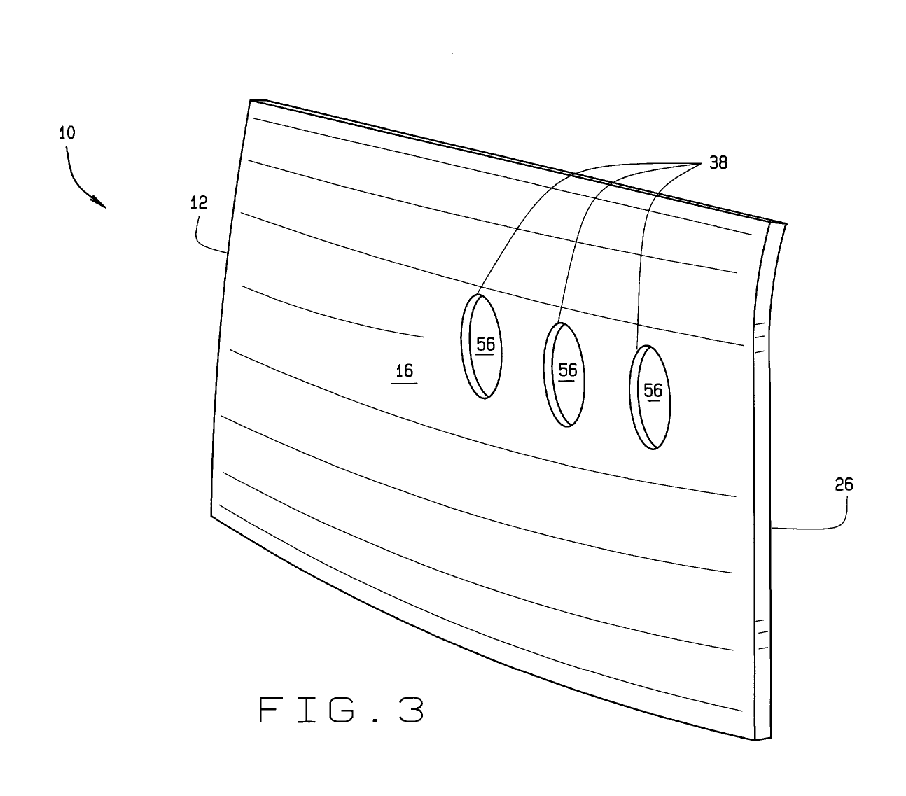

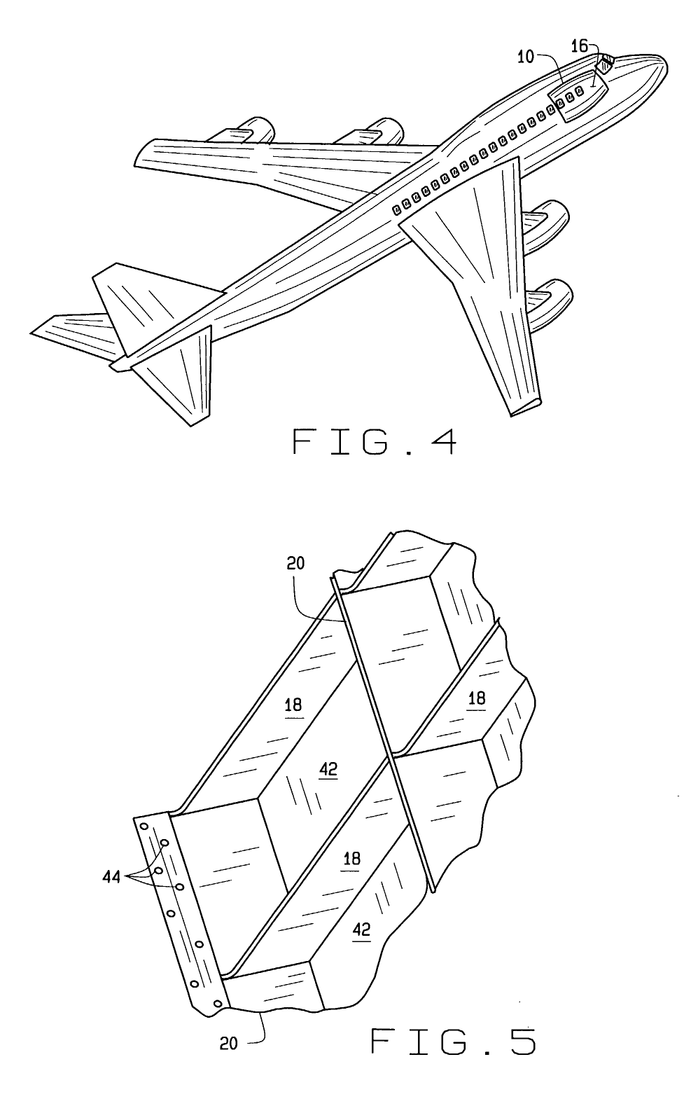

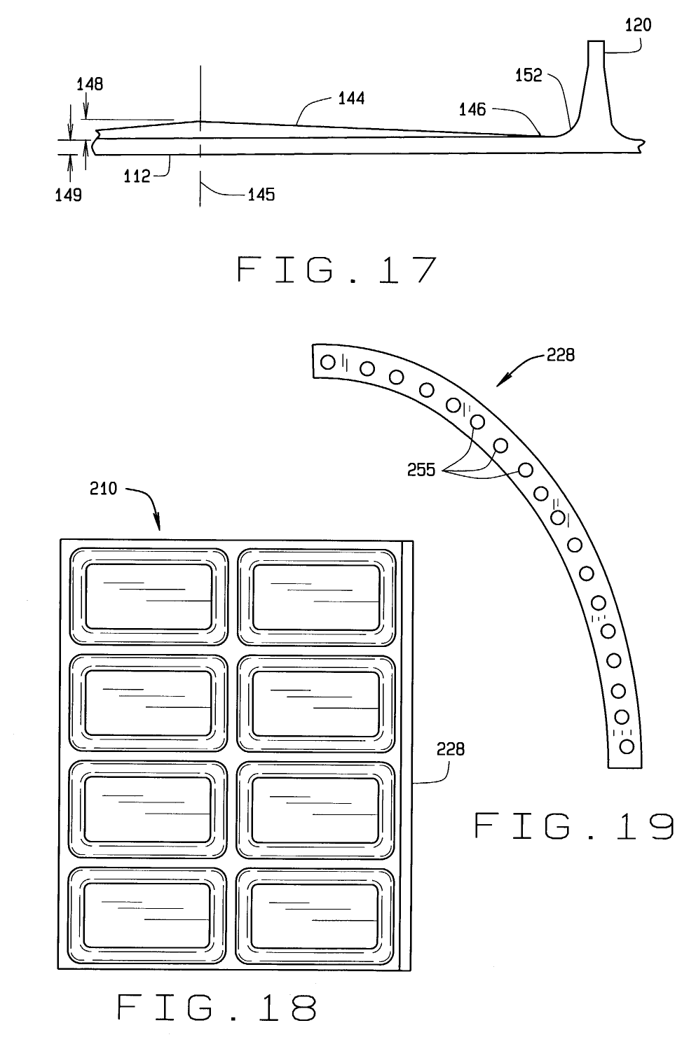

FIG. 4 is a perspective view of an exemplary aircraft 40 that is provided with the skin panel 10. It should be noted, however, that the skin panels of the present invention should not be limited to the particular fuselage location shown in FIG. 4 or restricted to the fuselage itself. That is, one or more of the skin panels may be configured (e.g., uniaxially curved, biaxially curved, etc.) to be disposed at other fuselage and aircraft locations without departing from the spirit and scope of the present invention. For example, in an alternative embodiment shown in FIGS. 18 and 19 but described in detail below, the skin panel 210 is configured to be disposed adjacent to and joined with an aft pressure bulkhead of an aircraft. The invention also applies equally to other aircraft structures that translate loads between axially load carrying skins and stiffening features (e.g., ribs, stiffeners, frame outer chords, stringers, etc.) and/or flanges. The aircraft structures for which the present invention may be suitable include but are not limited to fuselages, wings, empennages, pressure bulkheads, wing carry through sections, escape hatches, passenger doors, cargo doors, and access hatches and panels, among others.

Moreover, it should also be noted that the number, arrangement, geometry, shape, and dimensional size of the various components comprising the skin panels of the present invention may also vary from what is shown and described herein without departing from the spirit and scope of the present invention. Indeed, the particular skin panel configuration will likely depend at least in part on the particular application (e.g., type of aircraft, fuselage location, etc.) in which the skin panel is to be used.

The various components comprising skin panel 10 will now be discussed in more detail. Preferably, the skin panel 10 includes the axial load carrying skin 12 and an interior exoskeletal support structure wherein the skin 12 and the exoskeletal support structure are integrally formed or machined out of a parent material as a single component structure. As used herein, an axial load carrying skin shall be construed to be a skin capable of translating loads from and into stiffening features (e.g., ribs, stiffeners, stringers, frame outer chords, etc.) and/or flanges, wherein the axial loads can be either compression, tension or both compression and tension.

Accordingly, the stringers 18 and frame outer chords 20 are integrated with the axial load carrying skin 12 such that laps and holes through the skin 12 are not needed for fastening the stringers 18 and frame outer chords 20 to the skin 12. With the absence of fasteners and the reduction of the pillowing effect caused thereby, the present invention allows for an aerodynamically smooth outer skin surface 14 as is shown in FIG. 3.

As shown in FIGS. 1 and 2, the fuselage skin panel 10 includes a plurality of stringers 18 disposed substantially longitudinally across the inner skin surface 14. Each of the stringers 18 is preferably integrally formed (e.g., machined, milled, hogged out, among other processes) with the axial load carrying skin 12 and thus serve to integrally reinforce and stiffen the skin 12. An integrally formed axially load carrying skin panel also provides greater torsional strength and stiffness than that provided by conventional semi-monocoque skin panels.

The fuselage skin panel 10 may also include a plurality of frame outer chords 20 disposed substantially transversely across the inner skin surface 14. Each of the frame outer chords 20 is preferably integrally formed with the skin 12 and thus serve to integrally reinforce and stiffen the skin 12.

The geometry of the stringers 18 and frame outer chords 20 may vary. Preferably, however, the stringers 18 and frame outer chords 20 are shaped and sized according at least in part on the particular load case and the desired moment of inertia for accommodating the particular load case.

The stringers 18 and frame outer chords 20 may be arranged such that a pocket or bay 42 is disposed between each corresponding pair of stringers 18 and pair of frame outer chords 20. The skin panel 10 may comprise any suitable number of (i.e., one or more) pockets depending at least in part on the particular aircraft and fuselage location for the skin panel 10. The pockets 42 can be configured to whatever geometry is most suitable for translating the stress loads, which are local to the particular skin panel's utilization and operational requirements. For example, the pocket configurations may be variations of an isogrid, rectangular, or any other configuration suitable for the local conditions and requirements.

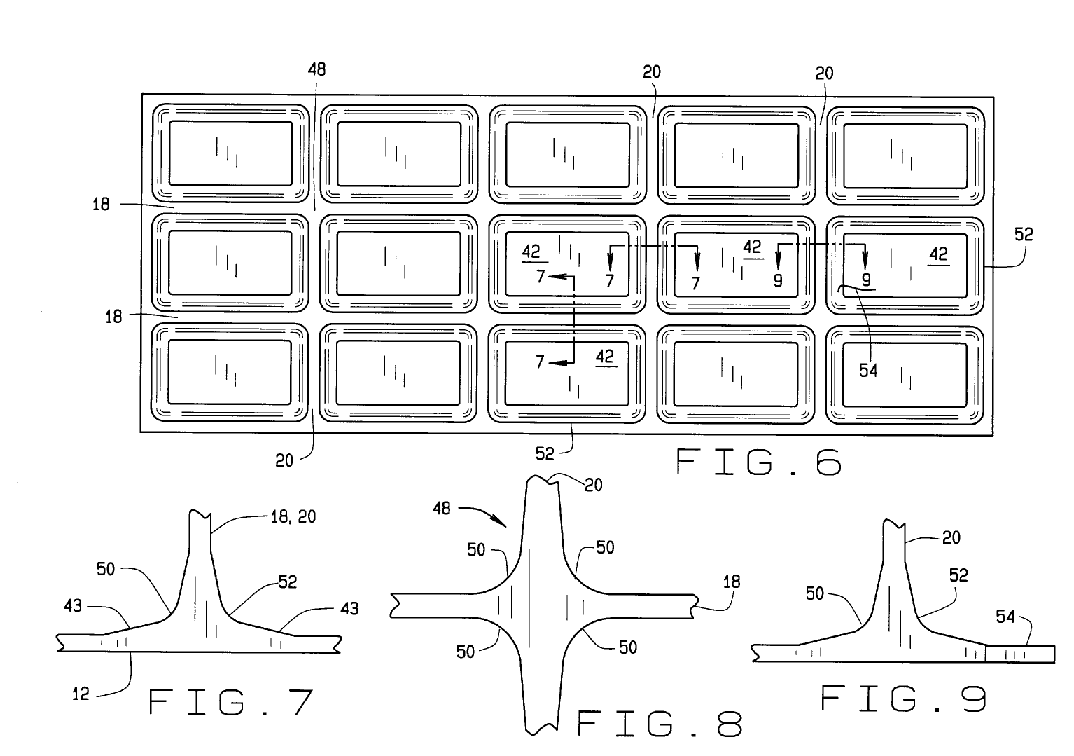

FIG. 5 is a detailed perspective view of the pocket 42, whereas FIG. 6 is an inward view showing a plurality of pockets 42 wherein a crack 54 has formed within one of the pockets 42. As shown, each pocket 42 is bounded or defined by at least two stringers 18 and two frame outer chords 20. The holes 44 (FIG. 5) provided in the corresponding frame outer chord 20 may be used to engage the frame outer chord 20 with a secondary or internal frame member 46 in a manner more fully described below.

FIG. 7 is a cross-sectional view taken along the planes 7-7 in FIG. 6 and shows “ramp up” transitions 43 between the pockets 42 and the stiffeners (e.g., stringers 18, frame outer chords 20, and flanges 22 through 28). FIG. 8 is a detailed upper view of an intersection 48 between one of the stringers 18 and a corresponding frame outer chord 20 showing the fillet design thereat. As shown in FIGS. 7 and 8, fillets 50 are preferably formed up to the stringers 18 and the frame outer chords 20 such that the fillets 50 together with the “ramp-up” transitions 43 define or produce a collar or pad-up 52 disposed substantially around the perimeter of each pocket 42.

FIG. 9 is a cross-sectional view taken along the plane 9-9 in FIG. 6 and shows a crack 54 disposed within the pocket 42 and collar 52 thereof. Preferably, each collar 52 is shaped and sized to prevent, or least hinder, cracks (e.g., 54) from propagating or spreading from the pockets 42 through the stiffeners (i.e., stringers 18, frame outer chords 20, and flanges 22 through 28). By reducing the stress concentrations in the pockets 42, the collars 52 cause cracks within the pockets 42 to turn away from the stiffeners. For example, a crack 54 propagating up a “ramp-up” transition 43 will ultimately turn to follow the path of lesser resistance, which is away from the stiffener. Accordingly, the skin panel 10 is provided with high damage tolerance and fatigue capabilities that in most cases will allow for the elimination of the structural failsafe design requirements and failsafe testing, both of which contribute to the cost of designing, testing and building a production airliner. Briefly, the failsafe requirements are the structural design requirements for alternate load paths that assure safe flight to landing after a failure.

The present invention at least accomplishes the objective of alternate load path design at the major structural element level rather than at the level of individual features being required to the individual elements. Thus, for example, the wing ribs would supply alternate load paths to the wing skins and vice versa, but each geometric feature of the wing ribs and skins would not be required to be individually divided into sub assembly details and secondarily attached. Current failsafe art makes it impossible to predict where cracks will initiate and at what rates they may be expected to propagate. The present invention, however, facilitates the development of robust finite element models, and thus allows for the design of structures that are robust, damage tolerant, lightweight, and essentially designed by automation to requirement and model. In short, the invention enables the automation of design by allowing and facilitating the development of robust finite element models.

Although it is not shown in the Figures, a hole may be provided at about the center of one or more of the nodes or rib intersections 48. The hole may extend downwardly into the intersection 48 without penetrating the skin 12 and be used for secondary system support and/or weight reduction.

Referring back to FIG. 1, the skin panel 10 may further include the flanges 22 through 28, each of which is disposed at about a respective substantially longitudinal or transverse edge of the skin panel 10. The flanges 22 through 28 allow the skin panel 10 to be connected with adjacent fuselage skin panels.

As before with the stringers 18 and frame outer chords 20, the flanges 22 through 28 may also be integrated or integrally formed with the skin 12. Indeed, the substantially longitudinal flanges 22 and 24 may comprise stringers 18 that are disposed at about the substantially longitudinal edges of the skin panel 10, whereas the substantially transverse flanges 26 and 28 may comprise frame outer chords 20 that are disposed at about the substantially transverse edges of the skin panel 10.

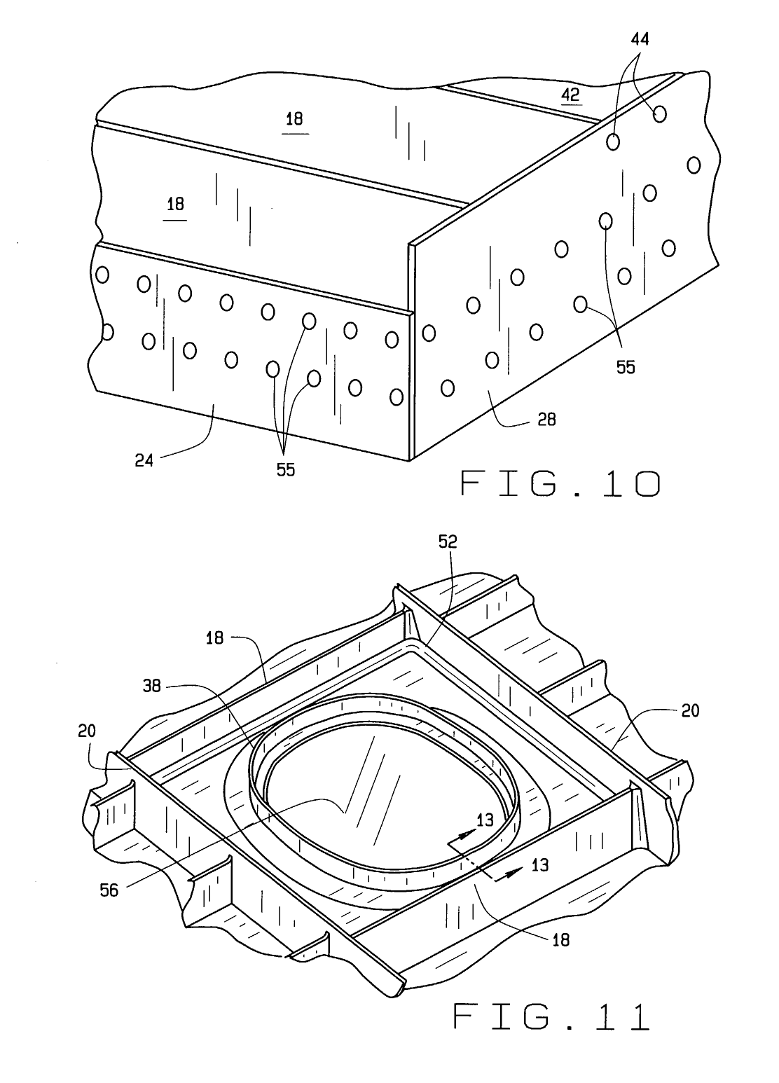

The flanges 22 through 28 may each be provided with two rows of holes 55, as is shown in FIG. 10 for the flanges 24 and 28. Each of the holes 55 is preferably sized to receive a tension fastener therein (e.g., a nut and bolt assembly, among tension fasteners). Accordingly, the fuselage skin panel 10 may be joined or attached to adjacent skin panels by using the tensions fasteners rather than lap shear joints. To do so, the tension fasteners are first inserted through the holes 55 provided in the flanges 22 through 28 and through corresponding holes in the adjacent skin panels. Then, the tension fasteners are tightened or fastened to secure the fuselage skin panel 10 to the adjacent skin panels.

Referring back to FIGS. 1 through 3, the skin panel 10 may include one or more integrally reinforced window frames 38. In the embodiment shown and described herein, the skin panel 10 includes three window frames 38, although a greater or lesser number of window frames may be provided depending on the particular aircraft and fuselage location in which the skin panel will be used.

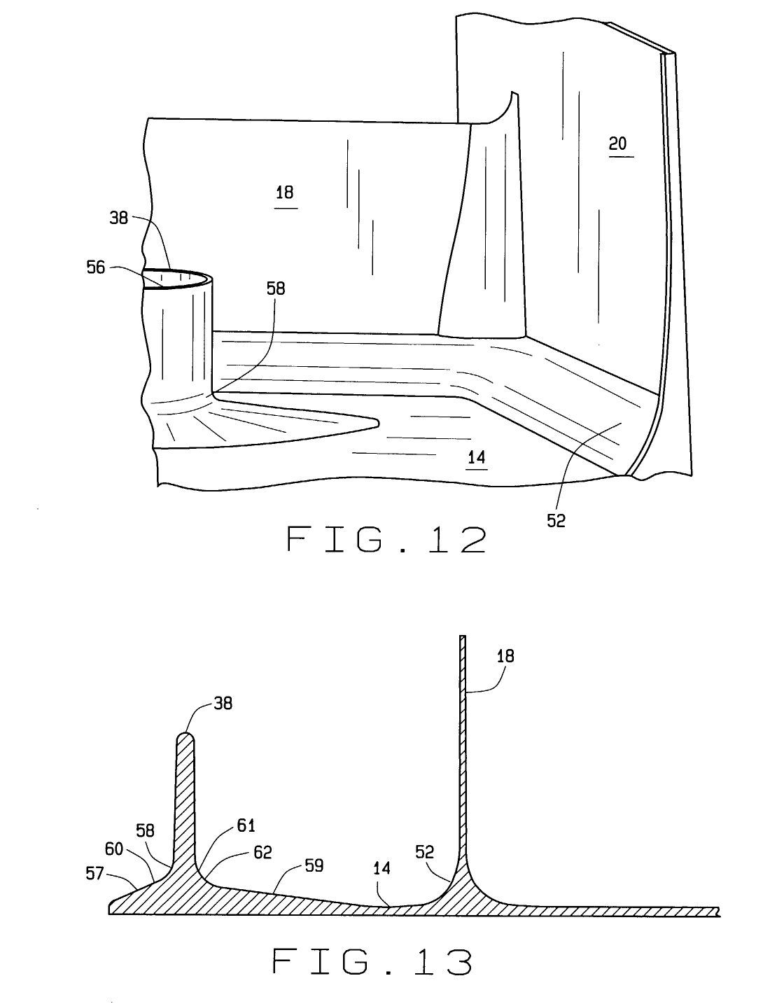

As shown in FIGS. 11 through 13, each window frame 38 is preferably integrally formed along with the other components 12, 18, 20, 22 through 28 of the skin panel 10 such that the window frames 38 need not be secondarily attached to the axial load carrying skin 12 or secondarily reinforced. Each window frame 38 defines an opening 56 to allow for the installation of a window therein. Preferably, the window frames 38 and the openings 56 defined thereby are elliptically shaped, although such is not required.

Each window frame 38 may be disposed within a corresponding pocket 42, as previously described. As best shown in FIG. 13, a “ramp-up” transition 57 may be disposed between the opening 56 and the widow frame 38. Similarly, a “ramp-up” transition 59 may also be disposed between the inner skin surface 14 and the window frame 38. Preferably, fillets 58 and 61 are formed from the respective transitions 57 and 59 up to the window frame 38. The fillet 58 and the “ramp-up” transition 57 together produce an inner collar or pad-up 60 disposed substantially around the inner perimeter of the window frame 38, whereas the fillet 61 and the “ramp-up” transition 59 together produce an outer collar or pad-up 62 disposed substantially around the outer perimeter of the window frame 38. Accordingly, the window frame 38 is integrally reinforced by the inner and outer collars 60 and 62. The preceding description regarding the incorporation of integral window frames 38 apply to other features equally such as door casings and system access panels.

Referring back to FIG. 5, one or more of the frame outer chords 20 is provided with a plurality of holes 44. The holes 44 may be used to engage the skin panel 10 with a secondary or internal frame member 46. The secondary frame member 46 comprises a frame inner chord that resembles a barrel hoop and that comprises a portion of the internal fuselage support frame.

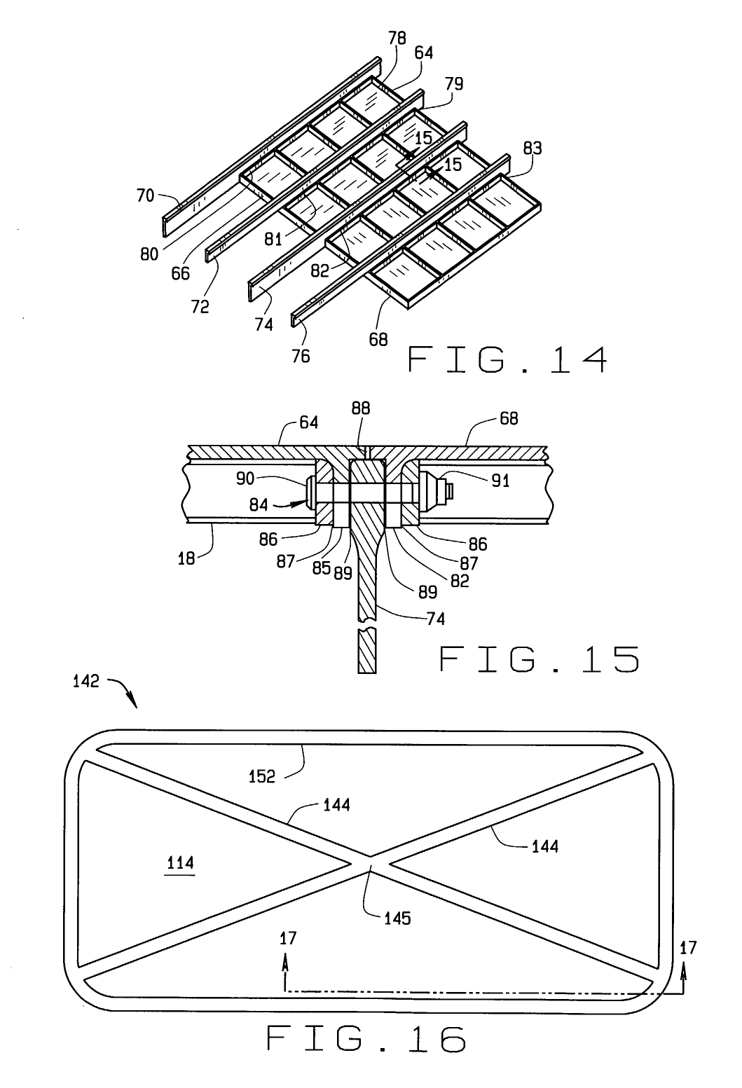

In FIG. 14, the secondary frame members 70 through 76 may be disposed either between two or more skin panels or within a channel defined by a frame outer chord. As shown, the secondary frame member 70 is engaged with a flange 78 of the skin panel 64 and a flange 80 of the skin panel 66. The secondary frame element 72 is engaged with the skin panels 64 and 66 while being disposed within a channel defined by a frame outer chord 79 of the skin panel 64 and by a frame outer chord 81 of the skin panel 66. The secondary frame member 74 is engaged with a flange 85 (FIG. 15) of the skin panel 64, a flange of the skin panel 66, and a flange 82 of the skin panel 68 and is thus disposed between the skin panel 68 and the skin panels 64, 66. The secondary frame element 76 is disposed within a channel defined by a frame outer chord 83 of the skin panel 68.

When disposed between two fuselage skin panels, the secondary frame member may provide additional stiffness and support, for example, at a major body joint such as a primary suction joins. When engaged within a channel defined by a frame outer chord, the secondary frame member may decrease rib spacing. In either case, the internal frame members may be used to increase the strength of the fuselage skin panel 10 without requiring the additional material to the previously existing components.

Referring to FIG. 15, the secondary frame member 74 is disposed between the fuselage skin panels 64 and 68 and engaged therewith via one or more mechanical fasteners 84 (e.g., hi-lock bolt 90 and collar 91, etc.) disposed within interference fit holes defined through the flanges 85 and 82 of the skin panels 64 and 68, respectively. A load spreader 86 may be disposed between the flange 82 and the collar 91 and between the flange 85 and the end portion of the hi-lock bolt 90. In addition, a bedding compound 87 may be used to substantially fill up any irregularities in the surface contours of the load spreaders 86 and the flanges 82 and 85 and thus hinder the formation of stress risers to provide a more equal load distribution. The bedding compound 87 may comprise a fiber-filled two-part epoxy, although other bedding compounds may be used.

To assist with fluidic sealing, a resilient sealing member 88 may be disposed at the junction of the two skin panels 64 and 68. Accordingly, the seal 88 assists in preventing water, corrosive liquids, among other fluids from penetrating the fuselage. The resilient sealing member 88 may comprise silicone, although other materials are also possible.

A structural bond or adhesive 89 may be disposed between the frame inner chord 74 and the flanges 82 and 85. Accordingly, the structural bond 89 allows stresses and strains to be more evenly distributed instead of being localized at the fastener 84. In addition, the structural bond 89 also helps to seal the junction between the frame inner chord 74 and the flanges 82 and 85.

FIG. 16 is an inward view of a pocket 142 according to a second embodiment of a fuselage skin panel 110. The pocket 142 may be provided with one or more straps or pad-ups 144 that are integrally formed with the pocket 142. Preferably, the pocket 142 is provided with two straps 144 that are disposed diagonally across the pocket 142 and intersect or cross at about the pocket center 145 in an “x” configuration. Accordingly, the diagonal straps 144 increase the stiffness of the pocket 142 and thus delay the buckling phenomena associated with torsion loading with only a minimal weight gain.

Referring to FIG. 17, each of the straps 144 preferably begins at about the collar 152 with a minimum thickness 146 and tapers to a maximum thickness 148 at about the pocket center 145. By way of example only, the maximum thickness 148 of each strap 144 may be substantially equal to the thickness 149 of the skin 12. In a manner similar to that described before for the collars 52, the straps 144 prevent, or least hinder, cracks from propagating or spreading to the other portions of the pocket 142. Such integral structures as are herein described will facilitate the further development, refinement and certification of tailored geometries and features which will provide robust finite element models that will in turn enable structures to exceed the intent of failsafe design by virtue of superior damage tolerance and slow crack growth rates. Such models will also enable design by element to the finite models and individual feature requirement.

Alternatively, the pocket 142 may be provided with any number of (i.e., one or more) straps 144 in any suitable arrangement. Indeed, the preferred process for creating the skin panels is machining, which is a relatively flexible process that allows for tailoring of the pockets to varying thickness and shape configurations.

FIG. 18 is an inward view of a fuselage skin panel 210 according to a third embodiment of the present invention, whereas FIG. 19 is a plan view of a substantially curved or ring flange 228 that is disposed at a substantially longitudinal edge of the skin panel 210. The ring flange 228 is preferably integrally formed along with the frame outer chords, stringers, and skin. Accordingly, the ring flange 210 has taken the place of a substantially transverse flange (e.g., 28). The ring flange 228 is preferably configured to allow the fuselage skin panel 210 to be joined to an aft pressure bulkhead of an aircraft. In comparison to the flange 28 of fuselage skin panel 10, the ring flange 228 is preferably heavier, contains a single row of holes 255 instead of two, and is substantially arcuate rather than straight.

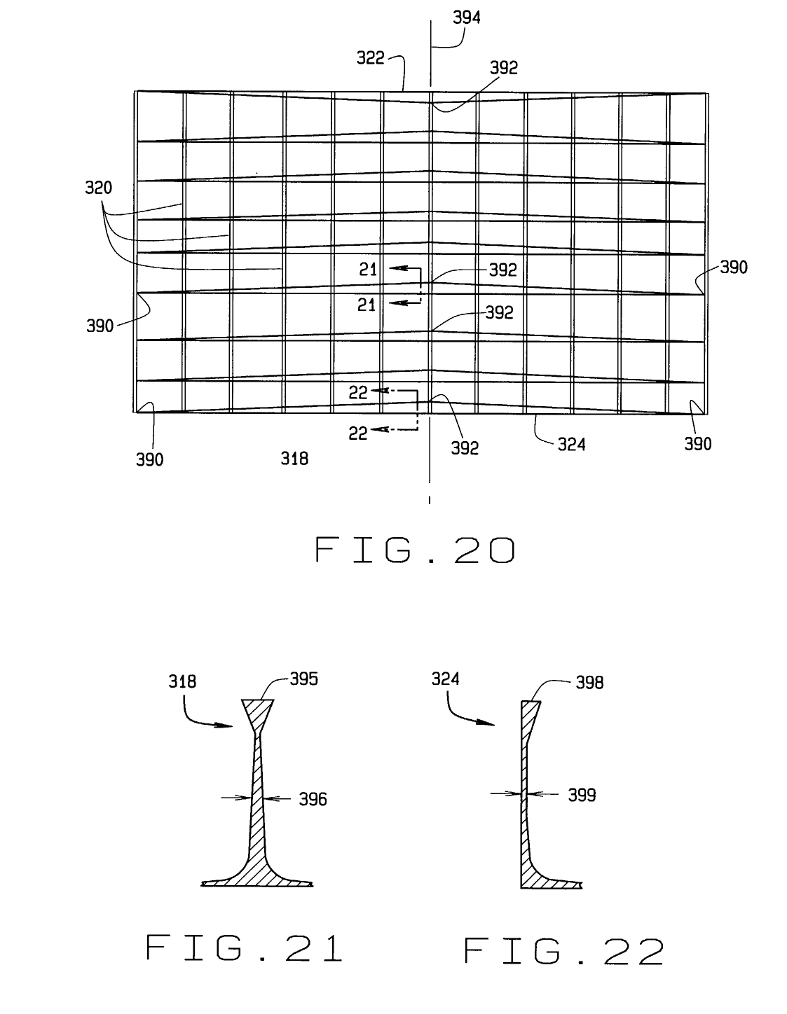

FIG. 20 is an inward view of a fuselage skin panel 310 according to a fourth embodiment of the present invention wherein the thickness of the medial portions of the stringers 318 and flanges 322 and 324 has been increased. The stringers 318 and substantially longitudinal flanges 322 and 324 each have a maximum thickness 392 at about the substantially longitudinal center 394 of the skin panel 310 and taper to a minimum thickness 390 at about the substantially transverse edges of the skin panel 310. Accordingly, the stiffness of the center portion of the skin panel 310 is increased, which in turn improves the skin panel's 310 ability to accommodate for and react to axial loading and torsional forces.

FIG. 21 is a cross-sectional view of a stringer 318 taken along the plane 21-21 in FIG. 20. As shown, a top portion 395 of the stringer 318 has a maximum thickness 390 that is substantially greater than the thickness 396 of the stringer web 397.

FIG. 22 is a cross-sectional view of the substantially longitudinal flange 324 taken along the plane 22-22 in FIG. 21. The top portion 398 of the substantially longitudinal flange 324 has a maximum thickness 392 that is substantially greater than the web thickness 399 of the substantially longitudinal flange 324.

In addition to increasing the thicknesses, the fillet properties at the interior junctions of the stringers 318 and the frame outer chords 320 may also be increased. Similarly, the fillet properties may also be increased at the interior junctions of the substantially longitudinal flanges 322 and 324 and the frame outer chords 20.

In another form, the present invention also provides methods for making an integrally stiffened axial load carrying fuselage skin panel. Generally, the method comprises the steps of integrally forming a skin, at least one stiffener to reinforce the skin, and at least one flange to allow the fuselage skin panel to be joined to an adjacent fuselage skin panel. In addition, the method may further comprise joining the fuselage skin panel to an adjacent skin panel by engaging at least one tension fastener with a flange of the skin panel and a flange of the adjacent skin panel.

The method may also include designing the skin panel in a substantially automated process by developing at least one robust finite element model of the skin panel, wherein the finite element model including at least one, but preferably all, required design elements. Another step of the method may include providing the skin panel with at least one smart structure damage detection component (e.g., but not limited to, crack detection and propagation gauges, strain gauges, stress and cycle gauges, smart paint which visually stains a cracked component, among others).

Yet another step of the method may include inspecting the skin panel for flaws and leaks using any one of a wide variety of inspection technologies that are not possible with the current structures. By way of example only, the skin panel may be inspected for flaws and/or leaks in the following manner. First, the fuselage of which the skin panel 10 is a, part is purged and pressurized with a gas such as helium. Next, the outer surface 16 of the skin panel 10 is inspected with a mass gas spectrometer or with a bubble leak test under a vacuum water bladder affixed on the panel 10 exterior skin 14.

Preferably, the skin panels have a constant diameter cross section and are made by pinch roll forming a blank or billet of a parent material to create a starting plate having a radius certified under FAR 25.605. Pinch roll forming varies from the normal slip roll forming process in that the pinch roll forming process reduces the cross sectional thickness of the material by compression by a factor sufficient to achieve the X51 or X52 stress relieved condition (normally the reduction is about 1.5-3.0% of beginning billet thickness). Preferably, an X51 or X52 mechanical stress relieved condition is achieved prior to machining, which in turn thus allows the dimensional stability dimensional stability required to machine to the precision required by determinate assembly operations to be achieved.

The billets are controlled by specification and inspected per FAR 25.605 to ensure acceptable material properties including low residual stress prior to the machining steps. In one embodiment, billets of 2024-T3 aluminum alloy having a thickness of about 3.1 inches (7.784 centimeters) are pinch roll formed to an acceptable radius and to the acceptable condition of having been mechanically stress relieved by the process compression to achieve the 2024-T352 condition. Although the pinch roll forming process would be suitable for the constant diameter cross section areas of the fuselage it would not lend itself well to the areas of compound curvature without extensive expenditure for specialized single application roll dies. Accordingly, in the areas of compound curvature, there would be employed other processes of pre-machining or post-machining contour forming as are determined appropriate to the geometry required. Some examples of these alternative forming technologies but not restricted to them, would be technologies such as High Energy Rate Forming (HERF) more commonly known as explosion forming, forging and others as are deemed appropriate to individual requirement. Methods for making integrally stiffened axial load carrying skin panels with machining and explosive forming are shown and described in more detail in the Unites States Patent Application titled “METHODS OF MAKING INTEGRALLY STIFFENED AXIAL LOAD CARRYING SKIN PANELS FOR PRIMARY AIRCRAFT STRUCTURE AND FUEL TANK STRUCTURES” of Sami M. El-Soudani, U.S. patent application Ser. No. ______, filed ______, which is commonly assigned with the present application, and the contents of which are incorporated herein by reference.

Next, the integral exoskeletal support structure and the skin may be created from the starting billet plate by using well known high-speed machining techniques. The outer surface of the starting plate is preferably clad or bare and possessed of the final product finish requirement in a fashion such that the starting plate need not be machined on the outside.

The machining process that may be used to produce the skin panels for the fuselage and/or other primary aircraft structures is preferably of the type of a fully integrated closed loop manufacturing system. In a closed loop system machining process, the chips are kept isolated and segregated within the process and thus kept pure and without loss of alloy purity. Such tightly controlled material segregation insures that the chips may be reused as original material rather than being recycled as scrap and thus the chip retain their value. That is, the chips are recovered and segregated without allowing any cross-contamination. The chips may then be recycled back to the melt and returned as new production process ready billets. For example, the fully integrated closed loop manufacturing operation preferably returns one days chips as another subsequent days billet stock without degradation of metallurgical material properties. Further, in an ideal closed loop manufacturing facility, the machining and material segregation and control would be located in close proximity to the mill operation, which creates the billets. Thus, the closed loop operation would be located adjacent to and within a distance of the mill that allows for automated conveyance of the billet to the machining operation from the mill and for the automated return conveyance of the materials to be recycled to the mill from the machining operation.

By using a “closed loop manufacturing machining system” to produce the skin panels and other primary structural components, the buy to fly ratios associated with the production of primary aircraft structures may be substantially decreased while incurring only minimal chip reprocessing charges coupled only with the cost of the utilized flight weight material shipped to assembly. In short, the closed loop manufacturing system has a significant positive impact upon the economics normally imposed by the material buy to fly ratio.

An exemplary closed-loop manufacturing system typically includes, but is not limited, to following major sequences. The mill formulates the original parent alloy and produces the billets. Next, the mill forms the billets to contour as required when the structure is formed prior to machining. The mill then transfers the stress-relieved billets to the machining operation. The machining operation would fixture and machine the billets to finished part configurations. The machining operation is preferably facilitated with automated chip recovery equipment that collects the chips, conveys them to a wash station for contaminant (e.g., coolant) removal, and compress the washed chips into briquettes. The briquettes are ultimately transferred back to the mill to be returned without property loss to the melt. Because the largest percentage of the cost to produce aluminum alloy is usually the energy required to produce new alloy, the closed-loop manufacturing concept delivers unparalleled economies to the integrally machined structures produced thereby.

Accordingly, the present invention provides integrally stiffened axial load carrying skin panels suitable for use with fuselage structures and other primary aircraft structural components wherein the various components comprising the skin panels are integrally formed as a single part or component structure. Thus, the present invention provides at least the following advantages over separately built-up aircraft structures:

(1) Reduces structural weight;

(2) Reduces detail part count;

(3) Reduces overall “Cost of Ownership” by virtue of lessened in service inspection and repair and also enhanced fatigue and thus service life;

(4) Reduces complexity and costs associated with design, manufacturing, and assembly of aircraft structures;

(5) Reduces Engineering Drawing tree coordination;

(6) Reduces aircraft drag associated with the fuselage skin;

(7) Enhances fuselage component life; and

(8) Facilitates the development of predictive finite element models that allow for a more automated design by finite model approach, which will further reduce the non-recurring costs associated with the design and certification of primary aircraft structures.

More specifically, the present invention allows for dramatic reductions in the number of detail parts and assemblies with a concomitant reduction in the costs associated with the design, manufacturing, assembly and maintenance when compared to that of separately built-up aircraft structures. The axial load carrying skin panels of the present invention can be designed, manufactured, assembled, inspected, maintained and repaired in a more efficient manner and in far less steps than conventional semi-monocoque structures.

The present invention eliminates the need for and thus the steps associated with drilling fasteners holes through the axial load carrying skins. Accordingly, the present invention eliminates a major culprit in the development of cracks, multi-site fatigue damage, fretting corrosion and costly aircraft inspection, refurbishing and maintenance. Current structures employ millions of internally stressed and point loaded fastener holes, which not only create the conditions defined above, but also create a condition where the points of initial nucleation are impossible to predict with any level of assurance. Conversely, the integral structure naturally disposes itself well to predictive behavior and finite modeling in support of automated design technologies.

With the present invention, all or nearly all fastener holes are preferably precision located full size at the time of part manufacture. Accordingly, ready-to-be-assembled axial load carrying skin panels may thus be delivered to the sub and final assembly operations without any in assembly manufacturing being required for the axial load carrying skin panels. By doing so, a significant reduction in assembly costs concurrent with a significant reduction in assembly cycle time is achieved, which in turn provides resultant improvements in product cost, quality and delivery.

Because the integrally stiffened axial load carrying skins are preferably produced as single parts or component structures, the present invention eliminates the need for hundreds of in-process inspections and a finished machining inspection should suffice to certify conformity requirements. Additionally, once in service, less time will be needed for inspection and repair of the skin panels for the fuselage and other aircraft structures as a result of the higher damage tolerance and fatigue capabilities, substantially lower number of parts, and the absence of fasteners and holes through the axial load carrying skins.

The integral structure design also facilitates new families of inspection technologies and processes to be employed that are not possible with existing built-up structures. These inspection technologies can provide a vastly enhanced inspection detection threshold for flaw and/or leak detection and also allow for panel-to-panel inspections. As described earlier, one exemplary inspection method comprises first purging and pressurizing the fuselage of which the skin panel 10 is a part with a gas such as helium, and then inspecting the exterior 16 with a mass gas spectrometer or with a bubble leak test under a vacuum water bladder affixed on the outside 16 of the panel 10 being inspected. The inspection flaw detection capability of such a process would be many orders of magnitude superior to any inspection process available to a built-up structure and could be employed at a fraction of the time and cost associated with current inspection procedures.

The invention also enables a wide range of smart technologies, which are capable of continuous real-time in service monitoring of structure health, cycles, cycle intensity and condition. For example, the skin panel 10 may be provided with at least one smart structure damage detection component (e.g., crack detection gauge, a crack propagation gauge, strain gauge, stress and cycle gauge, smart paint which visually stains a cracked component, among others.) that is coupled to computer software. Accordingly, the integrity of the skin panel 10 may be continuously monitored and inspected via the computer software and the smart structure damage detection component. In the event of a potentially hazardous condition, a warning may be relatively instantly provided rather than having to wait for a schedule cycle check to ascertain the condition.

Although of limited or compromised value when applied to current built-up structures, smart structure damage detection technologies are vastly enabled and become product enablers when applied to the axial load carrying skin panels of the present invention and supported by sound finite element models. The invention thus provides for and facilitates the incorporation of higher detection resolution non-destructive testing procedures which enhance the product integrity resultant from the in service cyclic inspections.

The absence of laps and holes through the axial load carrying skin panels and the new provision of a uniform parent metal interface of the component geometries produced in accordance with the integral structure concept of the invention also reduce the effect of pillowing on the outer skin surface and eliminates skin contour warping. Skin contour warping is a common phenomenon that may occur when interference fasteners are driven through a skin to hold stringers and/or frame outer chords thereto and then the pressure associated with cabin altitude compensation is applied forcing the skins outward and restraining the cabin pressure solely against the rivet heads. In addition, the skin panels of the present invention can be produced from a substantially stress-free parent material so that a better skin contour is achieved. Accordingly, the present invention eliminates, or at least reduces the number of, costly work-arounds needed for joining contour mismatches and also provides skin panels with aerodynamically smoother outer skins.

Further, the present invention provides a lower weight aircraft structure. With the weight reductions afforded by the present invention, airline operators will be able to realize substantial fuel savings.

The present invention also allows for the ready replacement of fuselage skin panels among other primary aircraft structure skin panels without the need for tailored repair procedures to individual conditions as is now the practice. Assuming, for example, that a damaged skin panel needs replaced, a replacement skin panel would be produced and delivered as an aircraft-on-ground (AOG) part. Next, the damaged skin panel would be removed by disengaging the tension fasteners from the corresponding flanges of the damaged and adjacent skin panels and by applying dry ice or other means of refrigeration to the exterior of the damaged skin panel. The skin panel would then be caused to shrink and thus to pull free of the frame and adjoining skin panel flanges, thereby allowing the skin panel to be removed and replaced. Finally, the replacement skin panel would be pre-shrunk and inserted between the adjacent skin panels and to the frame, then the replacement panel would be secured by engaging the tension fasteners with the flanges of the replacement and adjacent skin panels.

It is anticipated that the invention will be applicable to other primary metallic structures of the aircraft, and not to just the fuselage alone. Accordingly, the specific references to the design and fabrication of the fuselage herein are for purposes of illustration and should not be construed as limiting the scope of the present invention. The concepts, geometries, philosophies and claims made herein apply equally to other aircraft structures that employ axial load carrying skins including, but not restricted to, wings, empennages, pressure bulkheads, wing carry through sections, escape hatches, passenger doors, cargo doors, access hatches and panels, etc.

Moreover, it is also anticipated that the invention will be applicable to any of a wide range of aircraft (e.g., but not limited to, fighter jets, commercial jets, private jets, propeller powered aircraft, among others) regardless of the manner in which the aircraft is piloted (e.g., directly, remotely, via automation, or in a combination thereof, among others). Indeed, the present invention should not be limited to just aircraft either. Rather, it is anticipated that the invention will be applicable to other large mobile platforms and thus might be used to produce other major mobile structures such as ship hulls and superstructures, etc. Accordingly, the specific references to aircraft herein should not be construed as limiting the scope of the present invention to only one specific form/type of aircraft or to aircraft alone.

The description of the invention is merely exemplary in nature and is in no way intended to limit the invention, its application, or uses. Thus, variations that do not depart from the substance of the invention are intended to be within the scope of the invention. Such variations are not to be regarded as a departure from the spirit and scope of the invention.

What is claimed is:

1. A skin panel, comprising:
an axial load carrying skin; and
at least one stiffener integrally engaged with the axial load carrying skin.

2. The skin panel of claim 1, wherein the at least one stiffener comprises at least one of a stringer, a frame outer chord, and a flange disposed at about an edge of the skin panel.

3. The skin panel of claim 1, further comprising at least one window frame integrally engaged with the axial load carrying skin.

4. The skin panel of claim 4, wherein the window frame comprises:
an outer collar disposed substantially around an outer periphery of the window frame; and
an inner collar disposed substantially around an inner periphery of the window frame.

5. The skin panel of claim 4, wherein:
the at least one stiffener comprises a plurality of stringers and a plurality of frame outer chords;
at least one pocket is disposed substantially between at least two of the stringers and at least two of the frame outer chords; and
the window frame is disposed within the pocket.

6. The skin panel of claim 1, wherein:
the at least one stiffener comprises at least one stringer and at least one frame outer chord; and
at least one fillet disposed at about a junction of the stringer and the frame outer chord.

7. The skin panel of claim 1, wherein:
the at least one stiffener comprises a plurality of stringers and plurality of frame outer chords; and
at least one pocket is disposed substantially between at least two of the stringers and at least two of the frame outer chords.

8. The skin panel of claim 7, further comprising a collar disposed substantially around a periphery of the pocket, and being integrally engaged with the axial load carrying skin.

9. The skin panel of claim 7, further comprising at least one strap disposed within the pocket, and being integrally engaged with the axial load carrying skin.

10. The skin panel of claim 1, wherein the at least one stiffener comprises at least one stringer configured to taper from a maximum height at about a substantially longitudinal center of the skin panel to a minimum height at about a substantially transverse edge of the skin panel.

11. The skin panel of claim 1, wherein the at least one stiffener comprises at least one flange disposed at about a substantially longitudinal edge of the skin panel, the flange being configured to taper from a maximum height at about a substantially longitudinal center of the skin panel to a minimum height at about a substantially transverse edge of the skin panel.

12. The skin panel of claim 1, wherein the axial load carrying skin and the at least one stiffener are integrally formed as a single component structure.

13. The skin panel of claim 1, wherein the at least one stiffener comprises a ring flange disposed at about an edge of the skin panel.

14. The skin panel of claim 1, wherein the at least one stiffener is configured for engagement with a secondary frame member.

15. The skin panel of claim 14, wherein the at least one stiffener defines a channel sized to at least partially receive the secondary frame member therein.

16. The skin panel of claim 1, further comprising at least one flange disposed at about an edge of the skin panel, and being configured for engagement with a secondary frame member.

17. The skin panel of claim 1, further comprising at least one smart structure damage detection component.

18. An aircraft comprising at least one integrally stiffened axial load carrying skin panel.

19. The aircraft of claim 18, wherein the skin panel comprises:
an axial load carrying skin; and
at least one stiffener integrally formed with the axial load carrying skin.

20. The aircraft of claim 19, wherein the at least one stiffener comprises:
at least one stringer;
at least one frame outer chord; and
at least one flange disposed at about an edge of the skin panel.

21. The aircraft of claim 18, wherein the skin panel comprises at least one integrally reinforced window frame.

22. A skin panel comprising an axial load carrying skin and at least one stiffener, wherein the skin panel is produced according to a method comprising integrally forming the axial load carrying skin and the at least one stiffener as a single component structure.

23. The skin panel according to claim 22, wherein the at least one stiffener comprises at least one of a stringer, a frame outer chord, and a flange disposed at about an edge of the skin panel.

24. The skin panel according to claim 22, wherein the skin panel further comprises at least one window frame integrally formed along with the axial load carrying skin and the at least one stiffener.

25. A method of making a skin panel, the method comprising integrally forming an axial load carrying skin and at least one stiffener as a single component structure.

26. The method according to claim 25, wherein the step of integrally forming an axial load carrying skin and at least one stiffener as a single component structure comprises integrally forming along with the axial load carrying skin at least one of a stringer, a frame outer chord, and a flange disposed at about an edge of the skin panel.

27. The method of claim 26, further comprising joining the skin panel to an adjacent skin panel by engaging at least one tension fastener with a flange of the skin panel and a flange of the adjacent skin panel.

28. The method according to claim 25, wherein the step of integrally forming integrally forming an axial load carrying skin and at least one stiffener as a single component structure comprises integrally forming at least one window frame along with the axial load carrying skin and the at least one stiffener.

29. The method of claim 25, wherein the step of integrally forming an axial load carrying skin and at least one stiffener as a single component structure comprises:
contour forming a parent material to create a starting plate; and
machining an interior portion of the starting plate to create the axial load carrying skin and the at least one stiffener.

30. The method of claim 29, further comprising the step of recycling the chips produced during the machining in a closed loop manufacturing process.

31. The method of claim 25, further comprising the step of providing the skin panel with at least one smart structure damage detection component.

32. The method of claim 25, further comprising the step of designing the skin panel in a substantially automated process by developing at least one finite element model of the skin panel, the finite element model including at least one required design element.

33. The method of claim 25, further comprising the step of inspecting the skin panel for flaws and leaks.
